(19) United States
(12) Patent Application Publication
(10) Pub. No.: US 2026/0119275 A1
(43) Pub. Date: Apr. 30, 2026

(54) SECURE DOCK-BASED NEURAL PROCESSING UNIT HANDOFF TO A CLOUD RESOURCE ON CLIENT DISCONNECT

(71) Applicant: DELL PRODUCTS L.P., Round Rock, TX (US)

(72) Inventors: Jacob Mink, Cedar Park, TX (US); Balasingh Samuel, Round Rock, TX (US); Mitchell Markow, Hutto, TX (US); Farzad Khosrowpour, Pflugerville, TX (US)

(21) Appl. No.: 18/930,221

(22) Filed: Oct. 29, 2024

(51) Int. Cl. G06F 9/50; G06F 11/14; G06F 21/60

(52) U.S. Cl. CPC G06F 9/5088; G06F 11/1407; G06F 21/602

(57) ABSTRACT

An information handling system includes a processor and a memory coupled to the processor. The information handling system receives multiple checkpoints generated by a computing device that is executing a workload and is docked at the computing device. In response to detecting that the information handling system is undocked from the computing device, the information handling system receives a checkpoint of the checkpoints from a cloud resource. The checkpoint is transmitted by the computing device to the cloud resource and is generated subsequent to the other checkpoints. In addition, the information handling system selects another information handling system to execute the workload based on the checkpoint.

### FIELD OF THE DISCLOSURE

The present disclosure generally relates to information handling systems, and more particularly relates to secure dock-based neural processing unit handoff to a cloud resource on client disconnect.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communication among information handling systems may be via networks that are wired, wireless, or some combination.

### SUMMARY

An information handling system includes a processor and a memory coupled to the processor. The information handling system is docked to a computing device and may receive multiple checkpoints from the computing device that is executing a workload. In response to detection that the information handling system is undocked from the computing device, the information handling system may receive one of checkpoint of the checkpoints from a cloud resource. This checkpoint may be transmitted by the computing device to the cloud resource and is generated subsequent to the other checkpoints. In addition, the information handling system may select another information handling system to execute the workload based on the checkpoint.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a distributed system of information handling systems for dock-based neural processing unit handoff to a cloud resource on disconnect of the client computing device, according to an embodiment of the present disclosure;

FIG. 2 is a flowchart of a method for dock-based neural processing unit handoff to a cloud resource on disconnect of the client computing device, according to an embodiment of the present disclosure;

FIG. 3 is a diagram of a system for dock-based neural processing unit handoff to a client computing device of one or more checkpoints of a workload execution, according to an embodiment of the present disclosure; and

FIG. 4 is a block diagram of an information handling system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

As high-performance artificial intelligence (AI) computing moves closer to edge computing devices, a natural extension of the technology is to place AI computations on a smart docking station, also referred to herein simply as a dock, to which a client computing device is currently connected. However, dock connections are generally at-will from a user perspective, while workloads are typically time-bound based on computational power and relative difficulty of the workload. As such, there may be instances wherein the workload is not done executing when the user disconnects from the docking station. Therefore, when a user disconnects the client computing device from the docking station, the client computing device cannot receive the results of the workload execution. To address this and other concerns, the present disclosure provides a system and method to secure dock-based neural processing unit handoff to a cloud resource on client disconnect.

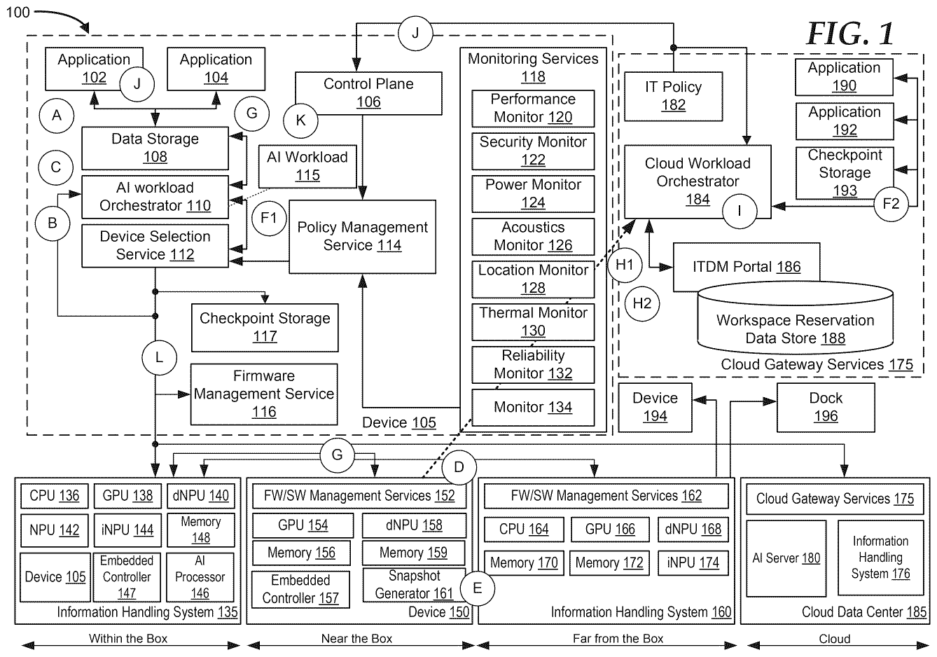

FIG. 1 illustrates a portion of a distributed system environment 100 for dock-based neural processing unit (NPU) handoff to a client computing device on disconnect of the client computing device, according to an embodiment of the present disclosure. Distributed system environment 100 includes a set of communicatively coupled information handling systems or computing devices, such as information handling systems 135 and 160, a device 150, and a cloud data center 185. Local and remote information handling systems in distributed system environment 100 may be communicatively linked either by hardwired data links, wireless data links, or a combination of hardwired and wireless data links through a network.

The network may be a public network, such as the Internet, a physical private network, a wireless network, a virtual private network, or any combination thereof. The network may be implemented as or may be a part of, a storage area network, a personal area network (PAN), a local area network (LAN), a metropolitan area network, a wide area network (WAN), a wireless local area network (WLAN), an intranet, or any other appropriate architecture or system that facilitates the communication of signals, data, and/or messages.

Information handling systems generally process, compile, store, and/or communicate information or data for business, personal, or other purposes thereby allowing users to take advantage of the value of the information. Nevertheless, a continually growing number of information handling systems and devices are being enhanced with AI services, such as heuristic learning, machine learning, deep learning, reinforcement learning services, and the like. Currently, most AI services are performed in central processing units (CPUs), graphics processing units (GPUs), system-on-chips (SOCs), NPUs, or other processors of the information handling system.

As the number of AI services increases, so will the need for computing resources to execute machine learning or AI models. Nevertheless, executing AI services in the information handling system, such as on-the-box (OTB) applications can inadvertently affect end-user productivity and negatively exhibit adverse effects, such as reduced battery life, system performance, and overall end-user experience. Conventional techniques to address this problem include AI hardware accelerators and AI software accelerators. However, these accelerators can be busy performing other tasks. In addition, these accelerators can be expensive and thus may not get integrated into low-cost platforms. Accordingly, embodiments of the present disclosure provide a system and method for preemptive and secure transitioning of AI workload to a premium information handling system, such as a dock using workspace reservation information.

However, a client computing device, such as information handling system 135, is docked to a smart dock, also referred to herein as a docking station, or simply a dock, such as device 150. The client computing device can disconnect from the docking station which can be currently executing an offloaded workload before the workload is finished its execution. The client computing device can also disconnect from the docking after the execution of the workload but before receiving the results of the execution. To have the ability to resume the execution when the client computing device disconnects from the docking station, the docking station may take one or more checkpoints of the workload while the workload execution is in progress if the workload is pipeline-able and the next input(s) are non-sensitive. The workload may be referred to as pipeline-able when its single model is a series of discrete steps, during each of which a set of inputs may be passed to a model, which can be the single model or several models, to produce an output that can be used as an input in a next step of the discrete steps. The inputs are non-sensitive when input metadata may restrict the transmission of the inputs to “off-the-box” resources, such as a docking station, another information handling system, a cloud resource, etc.

In one embodiment, the docking station has already completed the workload execution when the docking station detects that the client computing device disconnected from it. At this point, the docking station may connect to a mutually trusted cloud resource, such as cloud workload orchestrator 184. The cloud resource may be a virtual machine, application, service, storage, or any other resource that may be hosted in a cloud environment, such as cloud data center 185. The docking station may send the results of the workload execution to the cloud resource. The cloud resource may then connect to the client computing device and return the results of the workload execution to the client computing device.

In another embodiment, the docking station may not have completed the workload execution when the docking station detects that the client computing device disconnected from it. The docking station may notify a cloud resource that it was not able to complete the workload execution and transmit the latest checkpoint to the mutually trusted cloud resource, wherein the cloud resource may resume the execution of the workload based on the checkpoint. After completing the execution of the workload, the cloud resource may connect to the client computing device and return the results to the client computing device. By transmitting the workload to the cloud resource, the docking station may be free and/or have the compute availability to execute another workload when another client computing device docks into the docking station. In addition, the privacy of the workload may not be comprised by the other client computing device.

In yet another embodiment, the docking station may notify a cloud resource that it was not able to complete the execution of the workload and supply the input and configuration to the cloud resource. The cloud resource may retry the workload execution and return the results to the client computing device once the workload execution is complete. In certain instances, the cloud resource may not be able to execute the workload based on the checkpoint and/or supplied input and configuration. In this instance, the cloud resource may connect to the client computing device and notify the client computing device that the docking station was not able to complete the workload execution. The notification may include an instruction to resume or retry the execution of the workload. In addition, the notification may include the checkpoint, input, and configuration received from the docking station. This allows the client computing device to resume or retry execution of the workload after the selection of a suitable computing device or information handling system currently available within the distributed network environment. The client computing device may also offload the workload execution to another cloud resource.

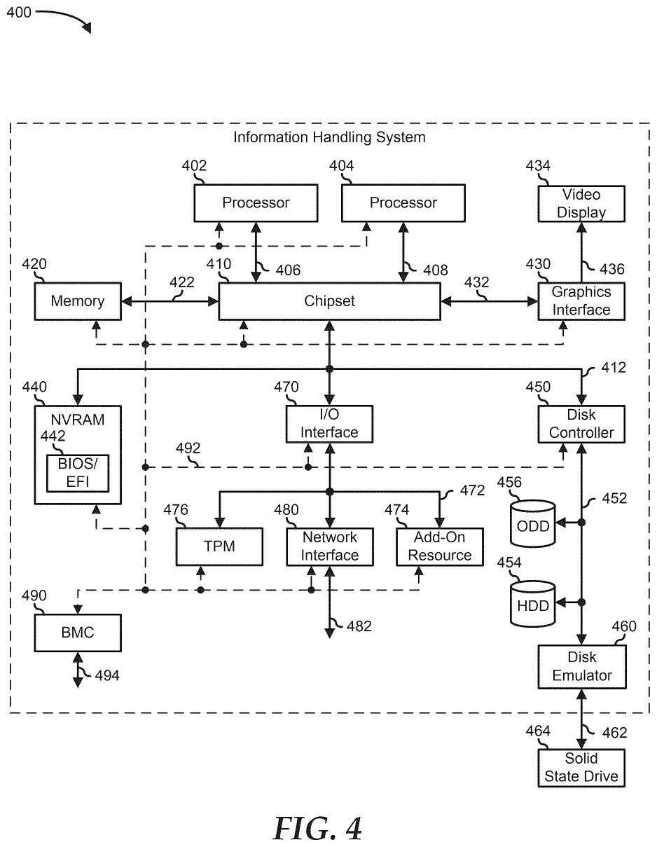

Information handling system 135, which is similar to information handling system 400 of FIG. 4 may be a personal computer, a desktop computer system, a laptop computer system, a server computer system, a mobile device, a tablet computing device, a personal digital assistant, a consumer electronic device, an electronic music player, an electronic camera, an electronic video player, a wireless access point, a network storage device, or any other suitable computing device. Information handling system 135 may also be a portable information handling system that may include a laptop, a notebook, a smartphone, a tablet, or a personal digital assistant, among others. In one example, information handling system 135 may be an employee's corporate laptop that he or she docks into device 150 upon arrival at a cubicle.

Information handling system 135 may be communicatively coupled to device 150 and information handling system 160. Information handling system 135 may also be communicatively coupled to cloud data center 185 via the Internet. In this example, information handling system 160 is communicatively coupled with a device 194 and a dock 196. Device 194 may be similar to device 105 while dock 196 may be similar to device 150. However, any variety of connections between various components of distributed system environment 100, such as connections between information handling systems 135 and 160, devices 105 and 194, and dock 196 with cloud data center 185 are envisioned as falling within the scope of the present disclosure. In addition, connections between components and within the various components of distributed system environment 100 are also envisioned as falling within the scope of the present disclosure. In addition, connections between components and within the various components may be omitted for descriptive clarity.

Information handling system 135 includes a device 105, a CPU 136, a GPU 138, a discrete NPU (dNPU) 140, an NPU 142, an integrated NPU (INPU) 144, an AI processor 146, an embedded controller 147, and a memory 148. CPU 136, which is similar to processors 402 and 404 of FIG. 4, may be configured to execute instructions of an application, such as applications 102 and 104. CPU 136 may also be configured to execute instructions associated with an AI workload orchestrator 110, a device selection service 112, a policy management service 114, and a firmware management service 116. In addition, CPU 136 along with GPU 138, dNPU 140, NPU 142, INPU 144, and AI processor 146 may be configured to execute workloads including an AI/machine learning workload, such as AI workload 115.

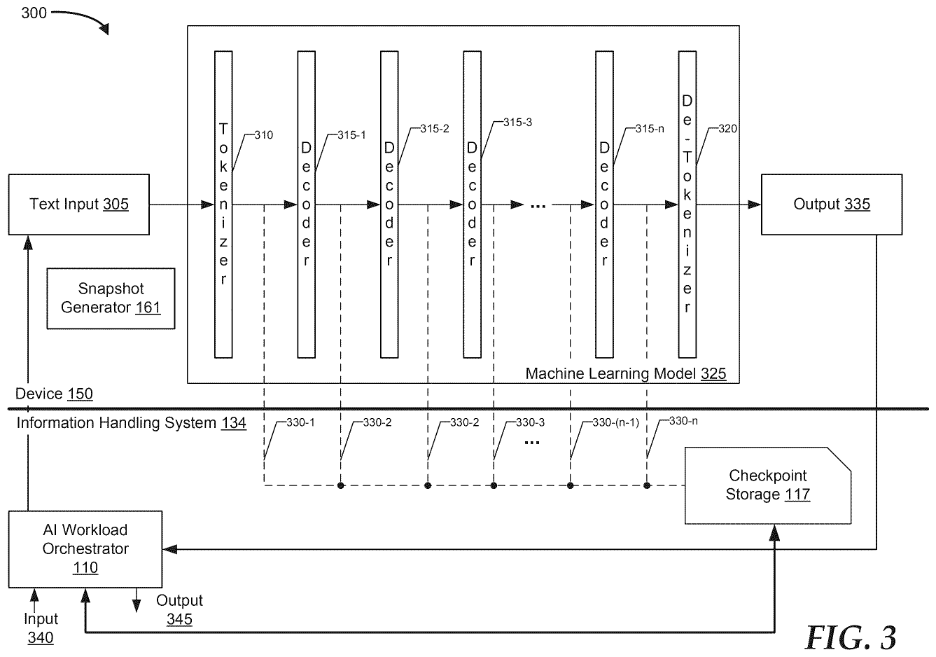

GPU 138, which may be similar to a graphics adapter 330 of FIG. 3, may comprise any system, device, or apparatus configured to process graphical or visual content and to communicate that content to a monitor or display where the content may be rendered. An NPU may comprise any system, device, or apparatus, such as a hardware accelerator that is designed for AI and ML tasks. NPUs are optimized to handle the complex computations required by deep learning algorithms. This optimization makes NPUs efficient at processing AI tasks, such as natural language processing, image analysis, and more. NPUs utilized by information handling system 135 may be of various types including dNPU 158, INPU 144, and AI processor 146. DNPU may be a discrete NPU, such as an NPU in a USB stick. An NPU may also be integrated with information handling system 135. INPU 144 may be connected via an m.2 slot within information handling system 135. AI processor 146 may comprise any system, device, or apparatus configured to process AI workloads.

Embedded controller 147, which may be similar to BMC 490 of FIG. 4, may comprise any system, device, or apparatus configured with a sideband connection to an embedded controller 157 of device 150. Embedded controller 147 may be configured to provide sideband access to embedded controller 157 of device 150 via a sideband connection in addition to or separate from a primary connection between device 150 and information handling system 135. The sideband connection may be used to configure device 150 to execute AI workload 115. The sideband connection may also be used to transmit information from embedded controller 157 subsequent to the configuration of device 150. Further, the sideband connection may be used by embedded controller 157 to receive a notification from embedded controller 147 to configure device 150.

Sideband access provides access to operations that are separate from primary operations or functions of device 150, such as transmitting large amounts of data, providing power and/or data to peripheral devices, etc. The sideband connection may be provided by an Inter-Integrated Circuit (I2C) sideband bus and/or other sideband communication interface. The sideband connection may also be a Bluetooth®, near-field communication (NFC), or similar. In addition, the sideband connection may be transmitted via a short wave signal via a transceiver which can be included in embedded controllers 147 and 157. Embedded controller 147 may establish a connection with embedded controller 157 via a configuration channel (CC) line. In particular pins CC1 and CC2 may be used to establish and manage a source-to-sink connection. The CC line may be used to establish an initial connection between device 150 and information handling system 135. Embedded controller 157 may transmit configuration information that would allow device 150 to execute a workload. For example, embedded controller 157 may use the sideband connection to declare its capabilities to embedded controller 147.

Memory 148, which is similar to a memory 420 of FIG. 3, may comprise a non-volatile memory accessible by CPU 136, GPU 138, dNPU 140, NPU 142, INPU 144, device 105, or AI processor 146. However, each one of the aforementioned may be associated with a separate non-volatile memory device. Memory 148 may include a static random access memory (SRAM), a dynamic random access memory (DRAM), or any suitable device to support high-speed memory operations. In certain embodiments, memory 148 may combine both persistent, non-volatile memory and volatile memory. In certain embodiments, memory 148 may include multiple removable memory modules.

Device 105 includes a control plane 106, a data storage 108, AI workload orchestrator 110, device selection service 112, policy management service 114, firmware management service 116, a checkpoint storage 117, and applications 102 and 104. Applications 102 and 104 are applications installed locally on device 105, also referred to as on-the-box (OTB) applications. For example, application 102 may be a video telephony software program while application 104 may be a natural language processing application.

Control plane 106 may be configured to control or route data received from cloud gateway services 175 to one or more components of information handling system 135, such as policy management service 114. In one example, control plane 106 may route IT policy 182 to device selection service 112. Data storage 108 may be a persistent data storage device. Data storage 108 may include solid-state disks, hard disk drives, magnetic tape libraries, optical disk drives, magneto-optical disk drives, compact disk drives, compact disk arrays, disk array controllers, and/or any computer-readable medium operable to store data. Data storage 108 may include a database or a collection of files that is a central repository of data associated with workloads that are accessible by AI workload orchestrator 110 and applications 102 and 104. For example, AI workload orchestrator 110 and applications 102 and 104 may retrieve, store, and utilize data stored in data storage 108.

AI workload orchestrator 110 may be configured to monitor, control, and/or manage AI workloads instantiated using a CPU, GPU, NPU, or similar, such as AI workload 115. AI workload 115 generally refers to data associated with an AI service that is to be performed to generate one or more inferences based on the data. For example, AI workload 115 may include a set of input data, such as telemetry data, past profile recommendations, machine learning hints from other AI services, etc., that may be processed to generate one or more inferences. As such, AI workload 115 may include machine learning and deep learning workloads, such as tasks performed by AI systems which typically involve processing large amounts of data and performing complex computations.

For example, a typical machine learning workflow may include building a model from a sample dataset, evaluating the model against one or more additional sample datasets to decide whether to keep the model and to benchmark how good the model is, using the model in production to make predictions or decisions against live input data captured by an application. The training set, validation set, and/or test set can respectively include pairs of input datasets and output datasets that correspond to the respective input datasets.

Device selection service 112 may comprise any system, device, or apparatus configured to determine a physical and/or virtual device or information handling system to process or transition an AI workload according to a policy, such as IT policy 182. For example, device selection service 112 may determine whether to transition AI workload 115 to a trusted device or information handling system within distributed system environment 100 that includes an AI processor capable of executing an AI workload. An AI processor includes a GPU, CPU, NPU, dNPU, INPU, or similar that is capable of executing an AI workload. Typically, an OTB AI processor is prioritized over a “near the box” device or information handling system. However, the “near the box” device or information handling system is generally prioritized over a “far from the box” device or information handling system. Accordingly, the “far from the box” AI processor or information handling system is generally prioritized over a cloud resource.

Device selection service 112 and/or AI workload orchestrator 110 may gather data or information from monitoring services 118 or its components. The data or information may include current performance, power utilization, and acoustic and thermal levels, among others to characterize the current state or utilization of one or more components of information handling system 135. This information may be utilized to determine whether to offload AI workloads according to policy, such as IT policy 182 provided by policy management service 114. Policy management service 114 may comprise any system, device, or apparatus configured to manage, monitor, and/or control IT policies, such as policies associated with AI workload transitions.

Firmware management service 116 may comprise any system, device, or apparatus configured to communicate with relevant hardware post-device selection. For example, firmware management service 116 may interface with a specific vendor application programming interface (API) to an OTB hardware, to a hardware connected to information handling system 135, or it may pass through to external components in order to run the workload.

Checkpoint storage 117 may be configured to store a plurality of checkpoints from a docking station, computing device, or another information handling system. In a particular example, checkpoint storage 117 may be configured to store checkpoints generated by a snapshot generator 161 of device 150. Checkpoint storage 117 may be based on one or more data platforms such as relational databases, HADOOP™, etc. The checkpoints may be stored in various formats, such as text files, extensible markup language (XML) files, comma-separated values (CSV) files, etc. Checkpoint storage 117 may be in a persistent storage device such as a solid-state disk, hard disk drive, magnetic tape library, optical disk drive, magneto-optical disk drive, compact disk drive, compact disk array, disk array controller, and/or any computer-readable medium operable to store data.

Monitoring services 118 may be configured to monitor, control, and/or manage one or more features of information handling system 135 and/or device 105, such as the health and performance of device 105. As such, monitoring service 118 includes one or more monitoring services, wherein each monitoring service may monitor, control, and/or manage a feature of device 105. For example, monitoring service 118 includes a performance monitor 120, a security monitor 122, a power monitor 124, an acoustics monitor 126, a location monitor 128, a thermal monitor 130, a reliability monitor 132, and monitor 134. Monitoring services 118 can include other monitors or monitoring services than depicted herein as new information becomes available to information handling system 135 and/or monitoring services 118.

Performance monitor 120 may be configured to monitor, manage, and/or control the performance of device 105 and/or its components. For example, performance monitor 120 can collect performance metrics over time, at specified intervals, and generate logs that can be analyzed to identify system performance issues. Security monitor 122 may be configured to monitor, manage, and/or control security of device 105 and/or its components. For example, security monitor 122 can detect a security data threat with data associated with AI workload. Power monitor 124 may be configured to monitor, manage, and/or control power consumption of device 105 and/or its components. For example, power monitor 124 may determine the power consumption of each one of applications 102 and 104. Acoustics monitor 126 may be configured to monitor, manage, and/or control the acoustics level of device 105 and/or its components. For example, acoustics monitor 126 may provide a current acoustics level to performance monitor 120.

Location monitor 128 may comprise any system, device, or apparatus configured to determine the location and movement of information handling system 135, such as based on triangulation of network information or information accessible via the operating system, or a location subsystem, such as a global positioning system (GPS) module. Thermal monitor 130 may be configured to monitor, manage, and/or control thermal level of device 105 and/or its components. For example, thermal monitor 130 may receive temperature information from one or more temperature sensors. In addition, thermal monitor 130 may provide a current thermal level to performance monitor 120.

Reliability monitor 132 may comprise any system, device, or apparatus configured to monitor, manage, and/or control hardware or software issues that may affect the performance and reliability of information handling system 135. Monitor 134 may comprise any system, device, or apparatus configured to determine other information to be utilized by monitoring services 118 during the monitoring, managing, and/or controlling information handling system 135 and/or its components. For example, monitor 134 may be configured to support proximity sensors, including optical, infrared, and/or sonar sensors, which may be configured to provide an indication of a user's presence near information handling system 135, absence from information handling system 135, and/or distance from information handling system 135, such as near-field, mid-field, or far-field.

In general, computer networks are considered to be trusted according to the following rules: a. by default, provisioned information handling systems under the purview of an organization's information technology (IT) department are trusted by each other for many corporate information handling system users, and b. by default multiple systems registered with the same account are considered to be trusted for non-corporate users. IT administrators have the ability to create smaller groups within their organization, such as engineering laptops workstations, desktop computers, and based on the organization's policy on potential data sharing. Additionally, AI workload processes may consume a relatively large amount of processing resources, yet the results they provide often do not require instantaneous implementation, such as other process-intensive services. On certain conditions and based on the local resources, it could otherwise be better to send the data to another device or a trusted information handling system within an organization group with the capability to perform AI workloads, such as devices with “premium” AI capabilities like device 150. A premium device may include a dock, an M.2 connected NPU, a webcam, or similar that includes an AI processor.

Device 150 may be referred to as a “premium” or smart device with AI processing capabilities that can be utilized to process an AI workload, such as a firmware/software (FW/SW) service 152, a GPU 154, embedded controller 157, a dNPU 158, memories 156 and 159, and snapshot generator 161. Device 150 may be a dock or docking station, wherein information handling system 135 is connected, such as via a wired connection or a short-range wireless connection like Bluetooth®. Wi-Fi®, NearLink®, NFC, low-power wide-area network, ultra-wideband, Institutes of Electrical and Electronics Engineers (IEEE) 802.15, or similar. As such, device 150 may be a trusted device and classified as a “near the box” system relative to information handling system 135. In addition, physical devices or peripherals that are plugged in or associated with device 150 or other information handling systems that are physically connected to information handling system 135 or via a short-range wireless connection may also be classified as “near the box” devices or information handling systems. This includes a webcam, keyboard, monitor, or other devices that are connected to information handling system 135 and/or device 150.

FW/SW management service 152 may comprise any system, device, or apparatus configured to communicate with the relevant information handling system post-selection. For example, FW/SW management service 152 may interface with a device, component, or information handling system that will be leveraged on the device itself in order to run the AI workload. Accordingly, FW/SW management service 152 may be configured to receive an AI workload, run the AI workload locally, and then return the result to the source or display the result to the user. For example, FW/SW management service 152 may communicate via APIs to another information handling system, component, device, or to a cloud workload orchestrator, such as cloud workload orchestrator 184. In another example, FW/SW management service 152 may communicate with AI workload orchestrator 110.

GPU 154, which is similar to GPU 138, may comprise any system, device, or apparatus configured to process graphical or visual content and to communicate that content to a monitor or display where the content may be rendered. DNPU 158 may be similar to dNPU 140. Device 150 may include other AI processing units, also referred to as AI processors, similar to NPU 142, INPU 144, and AI processor 146. Memories 156 and 159 may be similar to memory 148. In one embodiment, memory 156 may be accessible by GPU 154 while memory 159 may be accessible by dNPU 158. However, GPU 154 and dNPU 158 may also be configured to share one memory.

Embedded controller 157, which may be similar to BMC 490 of FIG. 4, may comprise any system, device, or apparatus configured with a sideband connection to embedded controller 147. In addition to using the sideband connection when establishing a primary connection between information handling system 135 and device 150, embedded controller 157 may use the sideband connection to communicate with embedded controller 147. For example, embedded controller 157 may use the sideband connection to notify AI workload orchestrator 110 via embedded controller 147 to resume or retry AI workload 115 when the user disconnects information handling system 135 from device 150 while AI workload 115 is still being processed.

Information handling system 160 can be a physical or virtual computing device that includes an FW/SW management service 152, a CPU 164, a GPU 166, a dNPU 168, and memories 170 and 172. Information handling system 160 may also be coupled to device 194 and dock 196, which is similar to device 105 and device 150 respectively. In one embodiment, distributed system environment 100 may include a trusted workgroup that is configured in a trusted peer network. The trusted workgroup may include information handling systems 135 and 160, and device 150, wherein these information handling systems and devices may be configured with AI services. As such, information handling system 160 may be a “trusted peer” of information handling system 135. Thus, information handling system 160 may be available to share AI workload 115 similar to device 150. In this example, information handling system 160 may be deployed within a communication network but farther from information handling system 135 than device 150. For example, information handling systems 135 and 160 may be configured within a LAN. As such, information handling system 160 may be referred to as a “far from the box” system relative to information handling system 135. Accordingly, a computing device or information handling system that is configured within a local network similar to information handling system 160 may be deemed as far from the box relative to information handling system 135. For example, device 194 and dock 196 may also be deemed as far from the box.

Snapshot generator 161 may comprise any system, device, or apparatus configured to generate one or more checkpoints, wherein each checkpoint provides a snapshot of the state of a system. The checkpoint is taken in case of a system failure. For example, the checkpoint may be used directly or as a starting point for a new execution, picking up where it left off prior to failure.

FW/SW management service 162 may comprise any system, device, or apparatus configured with functionality that is similar to FW/SW management service 152. CPU 164 may comprise any system, device, or apparatus configured with functionality that is similar to CPU 136. GPU 166 may comprise any system, device, or apparatus configured with functionality that is similar to GPU 138. DNPU 168 may comprise any system, device, or apparatus configured with functionality that is similar to dNPU 140. INPU 174 may comprise any system, device, or apparatus configured with functionality that is similar to iNPU 144. Memories 170 and 172 may be configured similar to memory 148. In this example, memory 170 may be accessible by CPU 164 while memory 172 may be accessible by GPU 166. However, information handling system 160 may have more or less memories than shown. For example, information handling system 160 may have one memory that is accessible by CPU 164, GPU 166, dNPU 168, and iNPU 174.

Cloud data center 185 includes cloud gateway services 175, an information handling system 176, and an AI server 180. Cloud data center 185 may also include one or more racks that house information handling systems. In addition, other cloud data centers aside from cloud data center 185 may also be included as part of the cloud. In another embodiment, cloud gateway services 175 may be hosted by information handling system 176 or AI server 180. One or both of information handling system 176 and AI server 180 may be a physical or a virtual computing device. Cloud gateway services 175 includes a cloud workload orchestrator 184, an ITDM portal 186, a workspace reservation data store 188, IT policy 182, checkpoint storage 193, and applications 190 and 192. Checkpoint storage 193 may be similar to checkpoint storage 117, wherein checkpoint storage 193 may be used to store a plurality of checkpoints received from a docking station, computing device, or information handling system. Applications 190 and 192 are applications installed remotely on cloud gateway service 175, also referred to as on-the-cloud (OTC) applications. These applications may be discrete application entities, or they may work in conjunction with OTB applications of information handling systems within the network, such as applications 102 and 104.

Cloud workload orchestrator 184 may comprise any system, device, or apparatus configured to run an AI workload on an available cloud computer, which can be in a private cloud, or a cloud computing platform based on an IT policy. ITDM portal 186 may comprise any system, device, or apparatus configured to allow an ITDM or a user to set policy on distributed system environment 100 as a whole, a set of information handling systems, or an individual information handling system. ITDM portal 186 also allows the ITDM to participate in the allocation of the information handling systems or resources in distributed system environment 100. In addition, ITDM portal 186 further allows the ITDM, user, or cloud workload orchestrator 184 to look up forthcoming workspace reservations and decide where a machine learning model, a deep learning model, an AI workload, or similar should be run.

Workspace reservation data store 188 may comprise any system, device, or apparatus configured to allow cloud gateway services 175 to store and retrieve data, such as workspace reservations. In one embodiment, workspace reservation data store 188 may be similar to data storage 108. For example, workspace reservation data store 188 may include a magnetic hard disk storage drive or a solid-state storage drive. In certain embodiments, workspace reservation data store 188 may be a cloud system of storage devices that is accessible via network. Further, workspace reservation data store 188 may include a database or a collection of files that is a central repository of data associated with workspace reservations that are accessible by cloud workload orchestrator 184, ITDM portal 186, and/or applications 190 and 192. For example, cloud workload orchestrator 184 may retrieve, store, and utilize data stored in workspace reservation data store 188 via ITDM portal 186.

In modern enterprises, the term “hoteling,” shared workspaces, or co-working spaces collectively refer to physical environments where clients, users, or employees can schedule their hourly, daily, or weekly use of individual spaces, such as office desks, cubicles, or conference rooms, thus serving as an alternative to conventional, permanently assigned seating. In some cases, hoteling clients, users, or employees access a reservation system to book an individual space, such as a desk, a cubicle, a conference room, an office, etc. before they arrive at work, which gives them the freedom and flexibility to work wherever they want to. Each workspace may include its own set of peripheral devices or components, such as displays, webcams, microphones, speakers, headsets, printers, etc. When a client, user, or employee reaches the workspace, they typically bring their individual information handling system, connect their information handling system to a dock or docking station, and integrate with the set of peripheral devices or components.

Shared workspaces and computer equipment can be preconfigured based on location or utility. In today's work from home environment, employees infrequently visit office buildings. Cubicles, desks, and their accompanying computer equipment are thus shared by different employees in a hoteling arrangement. An employee can typically reserve a workspace using a portal online to select the workspace based on various factors, such as building, team locality, hardware, and length of time for usage. An example of a workspace reservation is shown below:

```
{
  “User”: “FirstName_LastName”,
  “Start_Time”: “2024/08/30 13:00:00 -05:00”
  “End_Time”: “2024/08/30 18:00:00 -5:00”
  “Country”: “United States”,
  “State”: “Texas”,
  “City”: “Austin”,
  “Office_Code”: “12345-3-1”
  “Workspace_Code”: “PS3-2-134-1”
}
```

When the employee arrives at the cubicle, desk, or other workspace, the employee's smartphone and laptop computer may be provisioned via wired or wireless network, such as WI-FI®, BLUETOOTH®, and other wireless networks serving the workspace. For example, provisioning may include FW/SW management services 152 determining whether there is an upcoming workspace reservation and whether there is an AI workload to be processed associated with the workspace reservation. The processing of the AI workload can also be triggered when the employee logs in. The devices or information handling system associated with the workspace reservation may also be pre-provisioned prior to the employee logging in. As such, the AI workload can be processed before the employee logs in. This enables optimization of the AI workload offload procedure.

IT policy 182 may comprise an IT policy or a set of IT policies that may indicate whether a given AI workload is eligible for migration, for example, based upon contextual information indicative of a level of processing required for that workload (e.g., whether an offload allowed or not allowed based upon AI processing capability, location requirement, security requirement, etc.). In one example, IT policy 182 may be a global IT policy as shown below:

```
{
  “IncludeCompute”: [“CPU”, “GPU”, “NPU”],
  “VideoWorkloads”: “Disabled”,
  “AudioWorkloads”: “Enabled”,
  “ExcludeDevicePattern”: “Intel ® iGPU*”
}
```

The above policy may enable the use of CPU, GPU, and NPU on the information handling systems included in distributed system environment 100 that the ITDM manages, such as information handling system 135 and 160, and device 150. According to this policy, video workloads would be disabled on the information handling systems and devices. However, this policy allows audio workloads. In this example, the IT policy would limit the use of the CPU, GPU, and NPU to clean up a meeting video but would allow the use of the CPU, GPU, and NPU to participate in cleaning up audio associated with the meeting.

In general, computer networks are considered to be trusted according to some rules, such as: a. by default, provisioned information handling systems under the purview of an organization's IT department are trusted by each other for many corporate information handling system users, and b. by default, multiple systems registered with the same account are considered to be trusted for non-corporate users. IT administrators have the ability to create smaller groups within their organization, such as engineering computing devices, workstations, etc. to trust other engineering computing devices or workstations, according to the organization's policy. For example, IT policy 182 may be configured as an engineering system group policy for a specific set or group of information handling systems as shown below:

```
{
  “LocalWorkloads”: {
    “Never”: {
      “ApplicationList”: [“Visual Studio”, “Creo ®”]
    },
    “NPUAvailable”: {
      “ApplicationList”: [“Teams ®”, “Zoom ®”, “VSCode ®”]
    }
  }
}
```

The above policy may apply to a set or group of information handling systems in an engineering domain that an ITDM manages. This policy may be configured to control when an AI workload can be run locally in one or more information handling systems in the engineering domain. In this example, local AI workloads may not be run locally if an end user is running a Visual Studio® or Creo® application. On the other hand, if the end-user is running Teams®, Zoom®, or VSCode®, then local AI workloads may run when there is a local NPU available.

In various embodiments, distributed system environment 100 may not include each of the components shown in FIG. 1. Additionally, or alternatively, distributed system environment 100 may include various additional components to those shown in FIG. 1. Furthermore, some components that are represented as separate components in FIG. 1 may in certain embodiments be integrated with other components. For example, in certain embodiments, all or a portion of the illustrated components may instead be provided by components integrated into one or more processors, such as a SOC.

FIG. 1 is annotated with a series of letters A-K. Each of these letters represents a stage of one or more operations. Although these stages are ordered for this example, the stages illustrate one example to aid in understanding this disclosure and should not be used to limit the claims. Subject matters falling within the scope of the claims can vary with respect to the order of the operations.

Prior to stage A, a user may connect a client computing device, such as information handling system 135 to a docking station, such as device 150. For example, the user may dock information handling system 135 to device 150. At stage A, application 102 may create a workload, such as AI workload 115 for processing. Application 102 may provide AI workload 115 to AI workload orchestrator 110. At stage B, AI workload orchestrator 110 with device selection service 112 may select a docking station, such as device 150 that information handling system 135 is currently docked into device 150 to execute AI workload 115. The selection may be based on various factors such as information from monitoring services 118.

At stage C, firmware management service 116 may direct embedded controller 147 to establish a sideband connection with embedded controller 157 of device 150. After establishing the sideband connection, embedded controller 147 may initiate an authorization process with embedded controller 157. When the authorization process is successful, at stage D, firmware management service 116 may offload AI workload 115 to device 150 via FW/SW management services 152. FW/SW management services 152 may determine which execution unit among GPU 154 and dNPU158 to run AI workload 115. Afterward, one of GPU 154 and dNPU 158 may execute the workload.

At stage E, at each stage of a pipeline during the workload execution, a checkpoint, also referred to as a snapshot, is generated for that particular stage of a pipeline-able workload. The checkpoint may be transmitted to information handling system 135 or cloud gateway services 175 based on availability or configuration by an information technology decision maker (ITDM). For example, the ITDM may allow checkpoints to be transmitted to cloud gateway services 175 upon disconnection of information handling system 135 from device 150 if device 150 has the capability to connect to cloud gateway services 175. Accordingly, the ITDM may disallow checkpoints to be transmitted to cloud gateway services 175 upon disconnection even if device 150 has the capability.

The checkpoint may be received by firmware management service 116 information handling system 135 at stage F1 or cloud gateway services 175 at stage F2. Firmware management service 116 may store the checkpoint at checkpoint storage 117. Cloud workload orchestrator 184 may store the checkpoint at checkpoint storage 193.

At stage G, AI workload orchestrator 110 and/or firmware management service 116 along with embedded controller 147 may detect that information handling system 135 disconnected from device 150. For example, the user undocked information handling system 135 from device 150. For example, the user may undock information handling system 135 before or after device 150 finishes executing AI workload 115. In another example, a power failure may occur, information handling system 135 may have shutdown unexpectedly, etc. Similarly, FW/SW management services 152 and/or embedded controller 157 may detect the disconnection or information handling system 135.

Information handling system 135 can disconnect from device 150 before or after the execution unit is finished processing AI workload 115. In one embodiment, information handling system 135 disconnected from device 150 while the execution unit is processing AI workload 115. If AI workload 115 is pipeline-able, such as when AI workload 115 includes decoder steps of a large language model, AI workload 115 can be represented as a series of stages with discrete transformations of input data to produce a certain output. Snapshot generator 161 of device 150 can take a checkpoint of the input data and the output of stages in the series that have already run along with the current stage's input data. Accordingly, at stage H1, FW/SW management services 152 may create and transmit a checkpoint of the current stage's input and output data. The checkpoint can be passed to cloud workload orchestrator 184, which stores the checkpoint in checkpoint storage 193.

If AI workload 115 is not pipeline-able, such as a large neural network producing a class value, like when AI workload 115 is atomic. In this instance, AI workload 115 cannot be represented as a series of stages. Accordingly, snapshot generator 161 cannot take a checkpoint of the input data and the output of the stage in the series. Thus, FW/SW management services 152 may notify information handling system 135, via the sideband connection, that it should prioritize re-scheduling of AI workload 115. Embedded controller 147 upon receipt of this notification, embedded controller 147 may inform AI workload orchestrator 110 of the notification. For example, embedded controller 147 may transmit the notification to AI workload orchestrator 110 and/or application 102. In another embodiment, FW/SW management services 152 may notify cloud workload orchestrator 184 that information handling system 135 has disconnected before processing of AI workload 115 is finished and it should notify application 102 and/or AI workload orchestrator to prioritize re-scheduling of AI workload 115. Cloud workload orchestrator 184 upon receipt of this notification may inform application 102 and/or AI workload orchestrator 110 of the notification.

In another embodiment, information handling system 135 is disconnected from device 150 after the execution unit finishes processing AI workload 115. At stage H2, FW/SW management services 152 may submit results of the completed workload associated with AI workload 115 to cloud workload orchestrator 184.

At stage I, cloud workload orchestrator 184, may receive the checkpoint or the results of the completed workload from FW/SW management services 152. At stage J, cloud workload orchestrator 184 may notify AI workload orchestrator 110 that it received the checkpoint or the results of the completed workload via control plane 106. If cloud workload orchestrator 184 received the results of the completed workload, then cloud workload orchestrator 184 may also return the results from the execution of the workload to information handling system 135 or application 102 in particular. At stage K, AI workload orchestrator 110 may receive the notification from cloud workload orchestrator 184 along with the results or checkpoint if any.

At stage L, AI workload orchestrator 110 may detect the disconnection of information handling system 135 from device 150. At this point, AI workload orchestrator 110 may determine whether it was informed to reschedule AI workload 115, that a checkpoint was transmitted to cloud workload orchestrator 184, or that a notification that AI workload 115 has finished execution. If AI workload orchestrator 110 determined that it was informed to reschedule AI workload 115, AI workload orchestrator 110 may determine whether it received a checkpoint and/or information associated with AI workload 115 for resubmission. As such, if AI workload orchestrator 110 received AI workload 115, then AI workload orchestrator 110 may reschedule the workload to another device, information handling system, or the cloud based on a selection of device selection service 112. Otherwise, AI workload orchestrator 110 may query application 102 for information associated with AI workload 115. Upon receipt of the query, application 102 may re-submit AI workload 115 to AI workload orchestrator 110 for re-scheduling.

If AI workload orchestrator 110 determined that a checkpoint may have been transmitted to cloud workload orchestrator 184, then AI workload orchestrator 110 may wait for a pre-determined time period to receive the checkpoint associated with AI workload 115 that was last submitted to cloud workload orchestrator 184. Otherwise, if the time period lapsed, then AI workload orchestrator 110 may query checkpoint storage 117 for the last checkpoint associated with AI workload 115 that it received from device 150.

AI workload orchestrator 110 may resume execution of AI workload 115 according to the checkpoint. For example, AI workload orchestrator 110 may resume or retry the execution of AI workload 115 locally, such as CPU 136, GPU 138, dNPU 140, NPU 142, INPU 144, or AI processor 146. In another example, AI workload orchestrator 110 may resume or retry the execution of AI workload 115 by offloading it to another computing device, such as device 150, information handling system 160, or via cloud data center 185 within distributed system environment 100 as selected by device selection service 112 depending on the availability and capability of the other device or information handling system.

In yet another embodiment, if AI workload orchestrator 110 received notification from a cloud resource that it resumed execution of AI workload 115, then AI workload orchestrator 110 may wait for a pre-determined time period for the results of the execution. If the results are not received when the time period lapsed, AI workload orchestrator 110 may query the cloud resource and/or reschedule the execution of AI workload 115. The time period may be based on how long AI workload 115 is expected to be processed plus an allowance for the transmission of the results.

Those of ordinary skill in the art will appreciate that the configuration, hardware, and/or software components of distributed system environment 100 may vary. For example, the illustrative components within distributed system environment 100 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for continuity of the description.

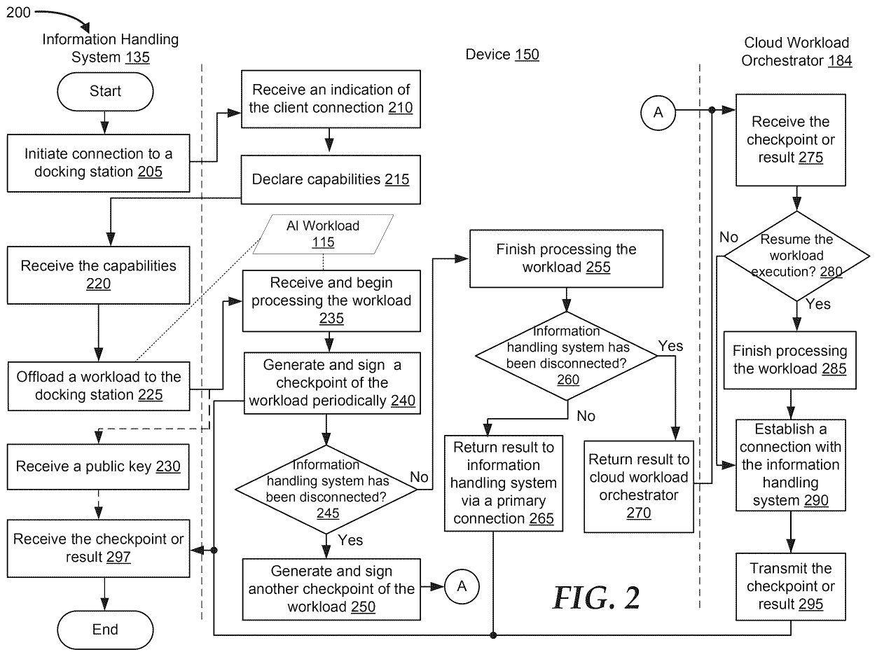

FIG. 2 illustrates a flowchart of a method 200 for secure dock-based neural processing unit handoff to a cloud resource on client disconnect. Method 200 may be performed by any suitable component of distributed system environment 100 including, but not limited to, information handling system 135 and device 150 of FIG. 1. While embodiments of the present disclosure are described in terms of the components of distributed system environment 100 of FIG. 1, it should be recognized that other components may be utilized to perform the described method. One of skill in the art will appreciate that this flowchart explains a typical example, which can be extended to applications or services in practice. It will be readily appreciated that not every method step set forth in this flow diagram is always necessary and that certain steps of the methods may be combined, performed simultaneously, in a different order, or perhaps omitted, without varying from the scope of the disclosure.

Method 200 typically starts at block 205 where a client computing device, such as information handling system 135, initiates a connection to a docking station, such as device 150. The connection may serve as a primary connection between information handling system 135 and device 150. For example, a user of information handling system 135 docks information handling system 135 into device 150. At block 210, device 150 may receive an indication of the primary connection from information handling system 135. At this point, device 150 may detect the primary connection. In addition, a sideband connection between embedded controllers of information handling system 135 and device 150 may be initiated.

At block 215, device 150 may declare and transmit its capabilities to information handling system 135 via the primary connection or the sideband connection. Device 150 may share its capabilities, such as workload sizing, number, type of NPUs, etc., securely through the primary or sideband connection. Device 150 may also include information on whether it can execute workloads, such as AI/machine learning workloads. In addition, the capabilities of device 150 may include information on whether it can connect to a cloud resource capable of executing or scheduling the execution of AI workload 115, such as cloud workload orchestrator 184. At block 220, information handling system 135 may receive the capabilities from device 150.

At block 225, a firmware management service of information handling system 135 may offload a workload, such as AI workload 115 to device 150 after determining that device 150 has a capability to execute the workload based on the capabilities received in block 220. The workload may be offloaded using the primary connection between the firmware management service of information handling system 135 and an FW/SW management service of device 150. AI workload 115 may include an identifier and a cryptographic nonce for identification and verification of a checkpoint associated with a workload execution or results upon fulfillment of the workload execution by device 150. The cryptographic nonce also referred to as a public key, may be pre-provisioned at information handling system 135 at manufacture and may have been stored in a non-volatile memory or a Read-Only Memory (ROM) device that is accessible by the embedded controller of device 150. A dashed line to block 230 indicates that transmission of the public key associated with AI workload 115 can be performed via a secondary pathway, such as the sideband connection. The transmission of the public key may be concurrent with offloading the workload or subsequent to receipt of the offloaded workload by device 150.

At block 230, information handling system 135 may receive the public key associated with AI workload 115. Information handling system 135 may receive the public key concurrently with the receipt of the offloaded workload at block 235. However, the public key may also be received after block 235 is initiated. At block 235, the FW/SW management service of device 150 may receive the offloaded workload from information handling system 135. The FW/SW management service may then provide the workload to an execution unit for processing. The execution unit may be a processor of device 150 capable of executing the workload, such as GPU 154 and dNPU 158 of FIG. 1.

At block 240, checkpoints may be generated and signed using a private key periodically by a snapshot generator at each discrete stage, such as snapshot generator 161, during the processing or execution of AI workload 115. The checkpoints may be transmitted to information handling system 135 via the sideband connection. In a particular example, the checkpoints may be transmitted using short wave radio signals. This frees up the primary connection for other tasks or processes, such as audio/video transmissions. Upon receipt of the checkpoint by the embedded controller, the checkpoint may be stored at a checkpoint storage device, such as checkpoint storage 117 of FIG. 1.

At decision block 245, information handling system 135 and/or device 150 may detect whether information handling system 135 has disconnected or undocked from device 150 while executing the workload. For example, device 150 may detect that the information handling system 135 is disconnected or undocked from device 150 while AI workload 115 is still running. If information handling system 135 has been disconnected or undocked, then the “YES” branch is taken, and the method proceeds to block 250. If the information handling system 135 has not been disconnected or undocked, then the “NO” branch is taken, and the method proceeds to block 255.

At block 250, the snapshot generator of device 150 may generate and sign another checkpoint based on a current stage of AI workload 115 execution if AI workload 115 is pipeline-able. A FW/SW management service may transmit the signed checkpoint to cloud workload orchestrator 184. The FW/SW management services may also instruct cloud workload orchestrator 184 to resume the execution of AI workload 115 based on the checkpoint. If AI workload 115 is not pipeline-able, then the FW/SW management services of device 150 may inform the cloud workload orchestrator that AI workload 115 may have to be re-scheduled. At block 255, the execution unit of device 150 may finish processing AI workload 115.

At decision block 260, device 150 may determine whether information handling system 135 has disconnected or undocked from device 150. If information handling system 135 has been disconnected or undocked, then the “YES” branch is taken, and the method proceeds to block 270. If the information handling system 135 has not disconnected or undocked, then the “NO” branch is taken, and the method proceeds to block 265. At block 265, the FW/SW management services of device 150 may return results of the workload execution via the primary connection between information handling system 135 and device 150. At block 270, the FW/SW management services of device 150 may return results of the execution to the cloud workload orchestrator 184.

At block 275, cloud workload orchestrator 184 may receive the checkpoint or results of the execution of AI workload 115 from device 150. Cloud workload orchestrator 184 may differentiate whether it received a checkpoint or result of a workload. The checkpoint or result may include information associated with an application that owns AI workload 115, information associated with information handling system 135, and/or any other information that may allow cloud workload orchestrator 184 to determine whether to resume processing AI workload 115 based on the checkpoint, notify information handling system 135 to reschedule execution of AI workload 115, or notify information handling system 135 that the execution of AI workload 115 is finished and provide the results to information handling system 135.

Because cloud workload orchestrator 184 may not receive the checkpoint unless the client computing device disconnected from the docking station, cloud workload orchestrator 184 may know that the workload execution associated with the checkpoint may have to be resumed by a cloud resource or a computing device or information handling system selected by information handling system 135. Accordingly, if cloud workload orchestrator 184 received the results of the workload execution, then cloud workload orchestrator 184 may know that the workload execution associated with the results is finished.

At decision block 280, cloud workload orchestrator 184 may determine whether to resume the workload execution based on the capabilities of components associated with cloud workload orchestrator 184. If cloud workload orchestrator 184 may resume the workload execution, then the “YES” branch is taken, and the method proceeds to block 285. If cloud workload orchestrator 184 may not resume the workload execution, then the “NO” branch is taken, and the method proceeds to block 290. At block 285, cloud workload orchestrator 184 may resume the workload execution based on the received checkpoint and finish processing the workload. Cloud workload orchestrator 184 may notify the AI workload orchestrator of information handling system 135 that it has resumed the workload execution of AI workload 115.

At block 290, cloud workload orchestrator 184 may establish a connection with a control plane of information handling system 135 via a network. The network may be implemented as or maybe a part of, a PAN, a LAN, a metropolitan area network (MAN), a WAN, a wireless local area network (WLAN), a virtual private network (VPN), an intranet, the Internet, or any other appropriate architecture or system that facilitates the communication of signals, data and/or messages. The network may transmit data using any communication protocol, including without limitation, Fibre Channel, Frame Relay, Asynchronous Transfer Mode, Internet Protocol, or other packet-based protocol. In addition, the network and its various components may be implemented using hardware, software, or any combination thereof. These components may be configured to facilitate communication between information handling system 135, device 150, and cloud workload orchestrator 184.

At block 295, cloud workload orchestrator 184 may transmit the checkpoint or result to information handling system 135 using the established connection. In particular, cloud workload orchestrator 184 may transmit the checkpoint or result to the application that owns the workload via a control plane of information handling system 135. In addition, when transmitting the checkpoint, cloud workload orchestrator 184 may include an instruction to resume/reschedule AI workload 115 based on the checkpoint included in the transmission. When transmitting the results of the workload execution, then the notification may include information that the workload execution of AI workload 115 is finished.

At block 297, an application of information handling system 135 may receive the transmission along with the checkpoint or results from cloud workload orchestrator 184. The firmware management service of information handling system 135 may also receive checkpoints or results of the workload execution from the FW/SW management services of device 150 while information handling system 135 is connected to device 150. Upon receipt of the checkpoint or results, the application, and/or the firmware management service of information handling system 135 may authenticate or verify the signed checkpoints and/or results using the public key.

On disconnection of information handling system 135 from device 150, information handling system 135 may have one or more checkpoints already in the checkpoint storage. In addition, based on the capabilities of device 150, the application may also receive the latest checkpoint from cloud workload orchestrator 184 or the results of the execution of AI workload 115 if cloud workload orchestrator 184 decides to execute AI workload 115. The application associated with the workload may provide a checkpoint from the checkpoint storage or cloud workload orchestrator 184 to the AI workload orchestrator as a priority for execution.

The AI workload orchestrator may determine whether device 150 is capable of connecting and transmitting checkpoints to a cloud resource, such as cloud workload orchestrator 184. If the AI workload orchestrator determines that device 150 is capable of connecting and transmitting a checkpoint to cloud workload orchestrator 184, then the AI workload orchestrator may wait for a configurable time period for a result and/or notification from cloud workload orchestrator 184 associated with AI workload 115 before resuming or rescheduling AI workload 115 entirely or from a checkpoint. The AI workload orchestrator may also compare a timestamp of the latest checkpoint received from device 150 and a timestamp of the checkpoint received from cloud workload orchestrator 184. Accordingly, when choosing to resume from a checkpoint, the AI workload orchestrator may choose the checkpoint with the latest timestamp.

If device 150 is not capable of connecting and transmitting checkpoints to a cloud resource, then the AI workload orchestrator may proceed with resuming or rescheduling AI workload 115 with priority. Assigning priority to AI workload 115 may allow the AI workload orchestrator to prioritize scheduling the execution of AI workload 115 either locally or offloaded to a selected computing device or information handling system before scheduling the execution of other workloads that have not been executed before, such as new workloads. Afterwards, the method ends.

FIG. 3 illustrates a portion of a system 300, which is a sub-system of distributed system environment 100 of FIG. 1, according to an embodiment of the present disclosure. System 300 includes information handling system 135 and device 150. Information handling system 135 includes AI workload orchestrator 110 and checkpoint storage 117. Device 150 includes a text input 305, a machine learning model 325, and an output 335. Machine learning model 325 includes a tokenizer 310, decoders 315-1 through 315-n, and a detokenizer 320. Each one of tokenizer 310, decoders 315-1 through 315-n, and detokenizer 320 may also be a machine learning model. In this example, machine learning model 325 can be a decoder-only machine learning model, which can be used to receive an input and predict tokens and/or words as output. Examples of decoder-only models include Generative Pre-trained Transformer 3 (GPT-3®), ChatGPT®, GPT-4®, Language Model for Dialogue Applications (LaMDa), etc.

Input to machine learning models used in executing the workloads herein may include samples, labeled or unlabeled datasets, images, raw data, images, etc. In this example, text input 305 can be unstructured data and/or natural language, such as text data in varied layouts or formats received from AI workload orchestrator 110. For example, text input 305 may include scanned documents, text-based portable document format (PDF) documents, etc. Output 335 can be a prediction or decision based on the evaluation of the input data. Output 335 can be in various formats, such as unstructured data and/or natural language similar to text input 305. Output 335 can also be a single value, an image, a probability distribution, a series of discrete values, etc. In one example, output 335 can be transmitted to AI workload orchestrator 110.

Tokenizer 310 may be an AI/machine learning model configured to process text input 305 into chunks of information that can be considered as discrete elements, which can be referred to as tokens. Depending on the application and the type of AI/machine learning model involved, the tokens may be characters, words, or even entire sentences. One common type of tokenization is tokenization into words. The words may be mapped to numeric values in an array. For example, a word tokenizer might tokenize an input “The cat is orange” into several tokens [the, cat, is, or, ange]. Each one of the tokens may be mapped to a numeric value. For example, the tokens [the, cat, is, or, ange] may be mapped to [5, 2334, 10, 25, 34457]. Tokenizer 310 may be a machine learning model that has been pre-trained to process a particular kind of input. A checkpoint may be generated subsequent to tokenization of text input 305 prior to proceeding with decoding the output of tokenizer 310. Decoders 315-1 through 315-n may comprise AI/machine learning models configured to interpret and analyze the tokens to generate text and/or additional tokens based on the input tokens. The generated text and/or tokens are generally provided to detokenizer 320. Each of decoders 315-1 through 315-n may be a pre-trained AI/machine learning model configured to take a current list of tokens as input and generate probabilities for each token. For example, an array of numeric values, such as [5, 2334, 10, 25, 34457], may be used as an input for decoder 315-1 to generate an output, such as [0.1, 0.0005, 0.1 . . . ] wherein the probabilities for the set of tokens sum up to 1. As such, in this example, the token “the,” which is a token zero in the array has a probability of 0.01, the token “cat,” which is a token one in the array has a probability of. 0005, etc. Decoder 315-1 may also generate a token based on the input and the generated probabilities. The generated token and probabilities may be stored in a key-value cache, wherein the tokens and/or numeric array generated by the tokenizer along with the data in the key-value cache and used as input for decoder 315-2 to generate another token and another set of probabilities which now includes a probability for the generated token. The generated tokens and second set of probabilities may be added to the data in the key-value cache. The tokens and/or numeric array generated by the tokenizer along with the data in the key value cached may be used as input for decoder 315-3 to generate a token and a third set of probabilities, and so on until a decoder generates a “stop token”, which a special token saying the decoder is unlikely to generate meaningful data anymore. Because each decoder may generate an output that can be used as an input for the next decoder in the series, each stage between the decoders may be an optimal opportunity to generate a checkpoint. Accordingly, snapshot generator 161 may generate a checkpoint between each of the decoders.

Detokenizer 320 may be an AI/machine learning model configured to receive the output of decoders 315-1 through 315-n as input and generate output 335. Detokenizer 320 may map the array of numeric inputs into tokens and combine the tokens into strings or text based on associated probabilities. For simplicity purposes, detokenizer 320 may receive an array such as [5, 2334, 10, 25, 34457, 334, 34567] and a set of probabilities associated with each numeric value in the array. Detokenizer 320 may map the numeric values into tokens, such as [the cat, is, or, ange, and tabby], and combine the tokens to reconstruct a text output like “the cat is orange and tabby.”

Snapshot generator 161 may periodically generate one or more checkpoints, such as checkpoints 330-1 through 330-n during the execution of the workload. Each of checkpoints 330-1 through 330-n may include an input, output from a previous stage, input for a next stage, and name or index of the next stage. The checkpoints may be transmitted via a primary or secondary connection to information handling system 135 for storage at checkpoint storage 117. An embedded controller of information handling system 135 may be configured to detect that information handling system 135 has disconnected from device 150 and notify AI workload orchestrator 110 of the disconnection. Accordingly, an embedded controller of device 150 may also detect the disconnection. After detecting the disconnection, snapshot generator 161 may generate another checkpoint, which device 150 may transmit to a cloud resource, such as cloud workload orchestrator 184 of FIG. 1.

AI workload orchestrator 110 may be configured to receive an input 340 and an output 345. Input 340 may include information associated with scheduling or executing a workload, such as an image, text, parameter, and/or associated values, etc. For example, input 340 may include text input 305. Input 340 may also include a notification, instruction, or other data from an application, a cloud resource, such as cloud workload orchestrator 184, or other components of distributed system environment 100 of FIG. 1. Output 345 includes one or more results of running an inference or workload, such as output 335 when machine learning model 325 finished its execution.

FIG. 4 illustrates an embodiment of an information handling system 400 including processors 402 and 404, a chipset 410, a memory 420, a graphics adapter 430 connected to a video display 434, a non-volatile RAM (NVRAM) 440 that includes a basic input and output system/extensible firmware interface (BIOS/EFI) module 442, a disk controller 450, a hard disk drive (HDD) 454, an optical disk drive 456, a disk emulator 460 connected to a solid-state drive (SSD) 464, an input/output (I/O) interface 470 connected to an add-on resource 474 and a trusted platform module (TPM) 476, a network interface 480, and a baseboard management controller (BMC) 490. Processor 402 is connected to chipset 410 via processor interface 406, and processor 404 is connected to the chipset via processor interface 408. In a particular embodiment, processors 402 and 404 are connected together via a high-capacity coherent fabric, such as a HyperTransport link, a QuickPath Interconnect, or the like. Chipset 410 represents an integrated circuit or group of integrated circuits that manage the data flow between processors 402 and 404 and the other elements of information handling system 400. In a particular embodiment, chipset 410 represents a pair of integrated circuits, such as a northbridge component and a southbridge component. In another embodiment, some or all of the functions and features of chipset 410 are integrated with one or more of processors 402 and 404.

Memory 420 is connected to chipset 410 via a memory interface 422. An example of memory interface 422 includes a Double Data Rate (DDR) memory channel and memory 420 represents one or more DDR Dual In-Line Memory Modules (DIMMs). In a particular embodiment, memory interface 422 represents two or more DDR channels. In another embodiment, one or more of processors 402 and 404 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 420 may further represent various combinations of memory types, such as Dynamic Random Access Memory (DRAM) DIMMs, Static Random Access Memory (SRAM) DIMMs, non-volatile DIMMs (NV-DIMMs), storage class memory devices, ROM devices, or the like. Graphics adapter 430 is connected to chipset 410 via a graphics interface 432 and provides a video display output 436 to a video display 434. An example of a graphics interface 432 includes a Peripheral Component Interconnect-Express (PCIe) interface and graphics adapter 430 can include a four-lane (×4) PCIe adapter, an eight-lane (×8) PCIe adapter, a 16-lane (×16) PCIe adapter, or another configuration, as needed or desired. In a particular embodiment, graphics adapter 430 is provided down on a system printed circuit board (PCB). Video display output 436 can include a DVI, an HDMI, a DisplayPort interface, or the like, and video display 434 can include a monitor, a smart television, an embedded display such as a laptop computer display, or the like.

NVRAM 440, disk controller 450, and I/O interface 470 are connected to chipset 410 via an I/O channel 412. An example of I/O channel 412 includes one or more point-to-point PCIe links between chipset 410 and each of NVRAM 440, disk controller 450, and I/O interface 470. Chipset 410 can also include one or more other I/O interfaces, including a PCIe interface, an Industry Standard Architecture (ISA) interface, a Small Computer Serial Interface (SCSI) interface, an I2C interface, a System Packet Interface, a Universal Serial Bus (USB), another interface, or a combination thereof. NVRAM 440 includes BIOS/EFI module 442 that stores machine-executable code (BIOS/EFI code) that operates to detect the resources of information handling system 400, to provide drivers for the resources, to initialize the resources, and to provide common access mechanisms for the resources. The functions and features of BIOS/EFI module 442 will be further described below.

Disk controller 450 includes a disk interface 452 that connects the disc controller to a hard disk drive (HDD) 454, to an optical disk drive (ODD) 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an institute of electrical and electronics engineers (IEEE) 1394 (Firewire) interface, a proprietary interface, or a combination thereof. Alternatively, SSD 464 can be disposed within information handling system 400.

I/O interface 470 includes a peripheral interface 472 that connects the I/O interface to add-on resource 474, to TPM 476, and to network interface 480. Peripheral interface 472 can be the same type of interface as I/O channel 412 or can be a different type of interface. As such, I/O interface 470 extends the capacity of I/O channel 412 when peripheral interface 472 and the I/O channel are of the same type, and the I/O interface translates information from a format suitable to the I/O channel to a format suitable to the peripheral interface 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on a separate circuit board, or add-in card disposed within information handling system 400, a device that is external to the information handling system, or a combination thereof.

Network interface 480 represents a network communication device disposed within information handling system 400, on a main circuit board of the information handling system, integrated onto another component such as chipset 410, in another suitable location, or a combination thereof. Network interface 480 includes a network channel 482 that provides an interface to devices that are external to information handling system 400. In a particular embodiment, network channel 482 is of a different type than peripheral interface 472 and network interface 480 translates information from a format suitable to the peripheral channel to a format suitable to external devices.

In a particular embodiment, network interface 480 includes a NIC or host bus adapter (HBA), and an example of network channel 482 includes an InfiniBand channel, a Fibre Channel, a Gigabit Ethernet channel, a proprietary channel architecture, or a combination thereof. In another embodiment, network interface 480 includes a wireless communication interface, and network channel 482 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 482 can be connected to an external network resource (not illustrated). The network resource can include another information handling system, a data storage system, another network, a grid management system, another suitable resource, or a combination thereof.

BMC 490 is connected to multiple elements of information handling system 400 via one or more management interface 492 to provide out of band monitoring, maintenance, and control of the elements of the information handling system. As such, BMC 490 represents a processing device different from processor 402 and processor 404, which provides various management functions for information handling system 400. For example, BMC 490 may be responsible for power management, cooling management, and the like. The term BMC is often used in the context of server systems, while in a consumer-level device, a BMC may be referred to as an embedded controller (EC). A BMC included at a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 490 can vary considerably based on the type of information handling system. BMC 490 can operate in accordance with an Intelligent Platform Management Interface (IPMI). Examples of BMC 490 include an Integrated Dell® Remote Access Controller (iDRAC).

Management interface 492 represents one or more out-of-band communication interfaces between BMC 490 and the elements of information handling system 400, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 400, that is apart from the execution of code by processors 402 and 404 and procedures that are implemented on the information handling system in response to the executed code.

BMC 490 operates to monitor and maintain system firmware, such as code stored in BIOS/EFI module 442, option ROMs for graphics adapter 430, disk controller 450, add-on resource 474, network interface 480, or other elements of information handling system 400, as needed or desired. In particular, BMC 490 includes a network interface 494 that can be connected to a remote management system to receive firmware updates, as needed or desired. Here, BMC 490 receives the firmware updates, stores the updates to a data storage device associated with the BMC, and transfers the firmware updates to the NVRAM of the device or system that is the subject of the firmware update, thereby replacing the currently operating firmware associated with the device or system, and reboots information handling system, whereupon the device or system utilizes the updated firmware image.

BMC 490 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 490, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSA) utility, a Dell EMC OpenManage Storage Services (OMSS) utility, or a Dell EMC OpenManage Deployment Toolkit (DTK) suite), a BIOS setup utility such as invoked by an “F2” boot option, or another protocol or API, as needed or desired.

In a particular embodiment, BMC 490 is included on a main circuit board (such as a baseboard, a motherboard, or any combination thereof) of information handling system 400 or is integrated onto another element of the information handling system such as chipset 410, or another suitable element, as needed or desired. As such, BMC 490 can be part of an integrated circuit or a chipset within information handling system 400. An example of BMC 490 includes an iDRAC, or the like. BMC 490 may operate on a separate power plane from other resources in information handling system 400. Thus BMC 490 can communicate with the management system via network interface 494 while the resources of information handling system 400 are powered off. Here, information can be sent from the management system to BMC 490 and the information can be stored in a RAM or NVRAM associated with the BMC. Information stored in the RAM may be lost after power-down of the power plane for BMC 490, while information stored in the NVRAM may be saved through a power-down/power-up cycle of the power plane for the BMC.

Information handling system 400 can include additional components and additional buses, not shown for clarity. For example, information handling system 400 can include multiple processor cores, audio devices, and the like. While a particular arrangement of bus technologies and interconnections is illustrated for the purpose of an example, one of skill will appreciate that the techniques disclosed herein are applicable to other system architectures. Information handling system 400 can include multiple central processing units (CPUs) and redundant bus controllers. One or more components can be integrated together. Information handling system 400 can include additional buses and bus protocols, for example, I2C and the like. Additional components of information handling system 400 can include one or more storage devices that can store machine-executable code, one or more communications ports for communicating with external devices, and various input and output (I/O) devices, such as a keyboard, a mouse, and a video display.

For purposes of this disclosure information handling system 400 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 400 can include processing resources for executing machine-executable code, such as processor 402, a programmable logic array (PLA), an embedded device such as a System-on-a-Chip (SoC), or other control logic hardware. Information handling system 400 can also include one or more computer-readable media for storing machine-executable code, such as software or data.

Although FIG. 2 shows example blocks of method 200 in some implementations, method 200 may include additional blocks, fewer blocks, different blocks, or differently arranged blocks than those depicted in FIG. 2. Those skilled in the art will understand that the principles presented herein may be implemented in any suitably arranged processing system. Additionally, or alternatively, two or more of the blocks of method 200 may be performed in parallel. For example, blocks 225 and 230 of method 200 of method 200 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that causes a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by an information handling system, a plurality of checkpoints generated periodically by a computing device that is executing a workload, wherein the information handling system is docked at the computing device;
in response to detecting that the information handling system is undocked from the computing device, receiving, from a cloud resource, a checkpoint generated by the computing device, wherein the checkpoint is transmitted by the computing device to the cloud resource, and wherein the checkpoint is generated subsequent to the checkpoints; and
selecting another information handling system to execute the workload based on the checkpoint.

2. The method of claim 1, wherein the checkpoints are generated at various stages of the executing of the workload.

3. The method of claim 1, wherein the computing device is communicatively coupled to the cloud resource.

4. The method of claim 1, further comprising receiving results of the executing of the workload from the cloud resource.

5. The method of claim 4, wherein the results are transmitted by the computing device to the cloud resource subsequent to the executing of the workload in response to detecting that the information handling system is undocked from the computing device.

6. The method of claim 4, wherein the results are signed using a private key.

7. The method of claim 1, wherein the information handling system receives an instruction from the cloud resource to resume the executing of the workload based on the checkpoint.

8. The method of claim 1, wherein the computing device is a docking station.

9. An information handling system, comprising:
a processor; and
a memory coupled to the processor, the memory having program instructions stored thereon that upon execution cause the processor to:
receive a plurality of checkpoints generated by a computing device that is executing a workload, wherein the information handling system is docked at the computing device;
in response to detecting that the information handling system is undocked from the computing device, receive a checkpoint of the checkpoints from a cloud resource, wherein the checkpoint is transmitted by the computing device to the cloud resource, and wherein the checkpoint is generated subsequent to the checkpoints; and
select another information handling system to execute the workload based on the checkpoint.

10. The information handling system of claim 9, wherein checkpoints are generated at various stages of the workload.

11. The information handling system of claim 9, wherein the other information handling system is another cloud resource.

12. The information handling system of claim 9, wherein the computing device transmitted results of the workload to the cloud resource subsequent to finishing the executing of the workload in response to the detecting that the information handling system is undocked from the computing device.

13. The information handling system of claim 12, wherein the information handling system receives the results of the workload from the cloud resource.

14. The information handling system of claim 9, wherein the information handling system receives an instruction from the cloud resource to resume the executing of the workload based on the checkpoint.

15. The information handling system of claim 9, wherein the cloud resource resumes the executing of the workload based on the checkpoint.

16. A method comprising:
generating, by a computing device, a plurality of checkpoints during execution of a workload of an information handling system, wherein the information handling system is connected to the computing device;
transmitting the checkpoints to the information handling system during the execution of the workload; and
generating and transmitting a checkpoint to a cloud resource in response to detecting that the information handling system is disconnected from the computing device during the execution of the workload.

17. The method of claim 16, wherein checkpoints are generated for various stages of the execution of the workload.

18. The method of claim 16, wherein the cloud resource resumes the execution of the workload based on the checkpoint.

19. The method of claim 16, further comprising transmitting a result of the execution of the workload to the cloud resource in response to the detecting by the computing device that the information handling system disconnected from the computing device subsequent to the execution of the workload.

20. The method of claim 19, wherein the information handling system receives the result of the execution from the cloud resource.
